(19) United States
(12) Patent Application Publication
(10) Pub. No.: US 2026/0152878 A1
(43) Pub. Date: Jun. 4, 2026

(54) MICROMIXER, SORTER DEVICE AND METHOD FOR MANUFACTURING FIBER

(71) Applicants: TOHOKU UNIVERSITY, Miyagi (JP); OKINAWA INSTITUTE OF SCIENCE AND TECHNOLOGY SCHOOL CORPORATION, Okinawa (JP)

(72) Inventors: YUANYUAN GUO, Miyagi (JP); SHUNSUKE KATO, Miyagi (JP); Amy Shen Fried, Okinawa (JP); Daniel Woodruff Carlson, Southampton (GB)

(73) Assignees: TOHOKU UNIVERSITY, Miyagi (JP); OKINAWA INSTITUTE OF SCIENCE AND TECHNOLOGY SCHOOL CORPORATION, Okinawa (JP)

(21) Appl. No.: 19/389,036

(22) Filed: Nov. 14, 2025

(30) Foreign Application Priority Data
Nov. 14, 2024 (JP) 2024-198972

(51) Int. Cl. D01D 5/253; B01F 25/00; B01F 25/4314; B01F 101/00; B07B 13/00; B07B 13/14

(52) U.S. Cl. CPC D01D 5/253; B01F 25/105; B01F 25/4314; B07B 13/006; B07B 13/14; B01F 2101/2805

(57) ABSTRACT

A micromixer, a sorter device, and a method for manufacturing fiber are provided. The micromixer includes a first portion configured to provide a first flow passage, and a second portion configured to provide a second flow passage branched from a middle of the first flow passage, wherein an inner wall of the second flow passage has a spiral shape along a longitudinal direction of the second portion.

### CROSS-REFERENCE TO RELATED APPLICATION

This application claims the priority benefits of Japanese application no. 2024-198972, filed on Nov. 14, 2024. The entirety of the above-mentioned patent application is hereby incorporated by reference herein and made a part of this specification.

### FIELD

The present disclosure relates to a micromixer, a sorter device, and a method for manufacturing a fiber.

### BACKGROUND

Non-patent literature 1 discloses the design and fabrication process for 3D microfluidic systems in the elastomer polydimethysi-loxane (PDMS) using 3D molding, without the use of photolithography. CAD programs are used for the design, and 3D printing technology is employed.

Non-patent literature 2 relates to optimal geometric parameters that enhance the mixing performance of a twisted microfluidic mixer. This literature aimed to explore the influence of pitch number, cross-section geometry, and eccentricity ratio on the performance of the twisted micromixer. In this literature, this literature attempts to estimate the mixing efficiency through calculation, specifically the numerical analysis of the flow field.

### PRIOR ART

### Non-Patent Literature

[Non-patent literature 1] Richmond, Tyler, and Nathan Tompkins. “3D microfluidics in PDMS: manufacturing with 3D molding.” Microfluidics and Nanofluidics 25.9 (2021): 76.
[Non-patent literature 2] Yousefi, Haniyeh, et al. “Improvement of mixing efficiency in twisted micromixers: The impact of cross-sectional shape and eccentricity ratio.” Chemical Engineering and Processing-Process Intensification 205 (2024): 110006.

### SUMMARY

### Technical Problem

In the technique disclosed in Non Patent Literature 1, a manufacturing method is complicated, and there are limitations on usable materials. The technique disclosed in Non Patent Literature 2 relates to theoretical calculations and provides little insight into manufacturing techniques.

Many conventional micro-fluid devices are manufactured using a lithographic method on a planar substrate, the lithographic method being a technique used in manufacturing semiconductors. In this case, there are problems such as limitations on material selection, complicated manufacturing steps, and restrictions to planar structures.

The present disclosure has been made to solve the above-described problems, and it is an object of the present disclosure to provide a new micromixer, a new sorter device, and a new method for manufacturing a fiber.

### Solution to Problem

A micromixer having a first portion configured to provide a first flow passage, and a second portion configured to provide a second flow passage branched from a middle of the first flow passage, wherein an inner wall of the second flow passage has a spiral shape along a longitudinal direction of the second portion.

Other features of the present disclosure are set forth below.

### Effects of Invention

A new micromixer, a new sorter device, and a new method for manufacturing a fiber can be provided.

### BRIEF DESCRIPTION OF THE DRAWINGS

FIG. 1A is a perspective view of the micromixer. FIG. 1B is an enlarged view of the second portion.

FIG. 2 is a view showing an example of a cross-sectional shape of the preform.

FIG. 3 is a view showing a twisted portion.

FIG. 4 is a view showing a twisted portion.

FIGS. 5A˜5C are cross-sectional views showing a modified example of the channel shape in the twisted portion. FIG. 5A shows a hole having a rectangular shape. FIG. 5B shows a hole having a triangular shape. FIG. 5C shows a hole having a circular shape.

FIGS. 6A˜6D are views showing an example of the fabrication of the micromixer. FIG. 6A shows a narrow groove formed in the straight flow passage portion. FIG. 6B shows a film. FIG. 6C shows an introduction passage having a tubular shape. FIG. 6D shows the separator fixed to the introduction passage and the second portion.

FIG. 7A shows that a fluid containing two kinds of particles flows through the spiral flow passages. FIG. 7B is a schematic view of FIG. 7A.

FIG. 8 is a perspective view of the sorter device.

FIG. 9 is a plan view of the separator.

FIG. 10A is a cross-sectional view of a preform. FIG. 10B is a photograph showing a portion of the preform and a portion of the fiber that is subjected to rotary hot drawing.

FIG. 11 is a view showing the process of subjecting the preform to a rotary hot-drawing treatment.

FIGS. 12A˜12C are diagrams illustrating the mechanism by which the spiral channel is deformed. FIG. 12A shows the cross section of the spiral channel before deformation. FIG. 12B shows that the spiral channel having a quadrangular shape was deformed by hot drawing performed with rotation. FIG. 12C illustrates the deformation mechanism of the spiral channel.

FIGS. 13A˜13B are views showing a preform having a second base body material. FIG. 13A is a cross-sectional view, and shows that a second base body material. FIG. 13B is a perspective view of the preform shown in FIG. 13A.

FIGS. 14A˜14B are photographs before and after the removal of the second base body material. FIG. 14A is a photograph of a cross section of the fiber before the second base body material is removed. FIG. 14B is a photograph of a cross section of the fiber after the second base body material is removed.

FIGS. 15A˜15B are photographs showing an example of the fabrication of a fiber having a spiral channel. FIG. 15A is a photograph of a cross section of the fiber that is subjected to rotary hot drawing. FIG. 15B is a photograph of the front side of the manufactured fiber.

FIGS. 16A˜16C are the results of a CT scan of the fabricated spiral channel. FIG. 16A shows an overview of the spiral channel. FIG. 16B shows a top-view image of the spiral channel. FIG. 16C is a bottom-view image of the spiral channel.

FIG. 17 is a calculation result showing the generation of two vortices in the spiral channel.

FIG. 18 is an experimental result showing the generation of two vortices in the spiral channel.

FIGS. 19A˜19C are diagrams showing the environmental dependence of the observation inside the spiral channel. FIG. 19A shows a spiral channel region. FIG. 19B is a photograph of the fiber observed in air. FIG. 19C is a photograph for a case in which the fiber is immersed into an oil.

FIG. 20 is a fluorescence photograph of the ROI taken after immersing the fiber in oil.

FIGS. 21A˜21D are cross-sectional views showing a method for manufacturing a micromixer according to another example. FIG. 21A shows that a microneedle is caused to come into contact with the second portion. FIG. 21B shows an adhesive agent. FIG. 21C shows that the microneedle is withdrawn. FIG. 21D shows that a first hollow needle and a second hollow needle.

FIG. 22 is a diagram showing an example of the use of the micromixer.

FIGS. 23A˜23B are captured image showing the state inside the channel. FIG. 23A shows an image of the inside of the channel photographed immediately after the two liquids were merged. FIG. 23B shows an image of the inside of the channel photographed at a position in the vicinity of the outlet.

FIG. 24A is a diagram showing experimental results obtained by investigating the dependence of mixing efficiency on Reynolds number for a straight mixer. FIG. 24B is a graph showing the influence of an eccentricity of the fiber on mixing efficiency.

FIGS. 25A˜25C are diagrams illustrating the eccentricity of the fiber. FIG. 25A shows a fiber whose eccentricity is 0. FIG. 25B shows a fiber whose eccentricity is 0.5. FIG. 25C shows a fiber whose eccentricity is 1.

FIG. 26 is a photograph of a cross section of an actually manufactured fiber having an eccentricity of 0.5.

FIG. 27A is a diagram showing an example configuration of a first portion. FIG. 27B is a cross-sectional view showing an example configuration of a second portion. FIG. 27C is a perspective view of the second portion.

FIG. 28 is a cross-sectional view showing a method for manufacturing a micromixer according to another example.

FIG. 29 is a cross-sectional view showing a method for manufacturing a micromixer according to another example.

### DESCRIPTION OF EMBODIMENTS

### First Embodiment

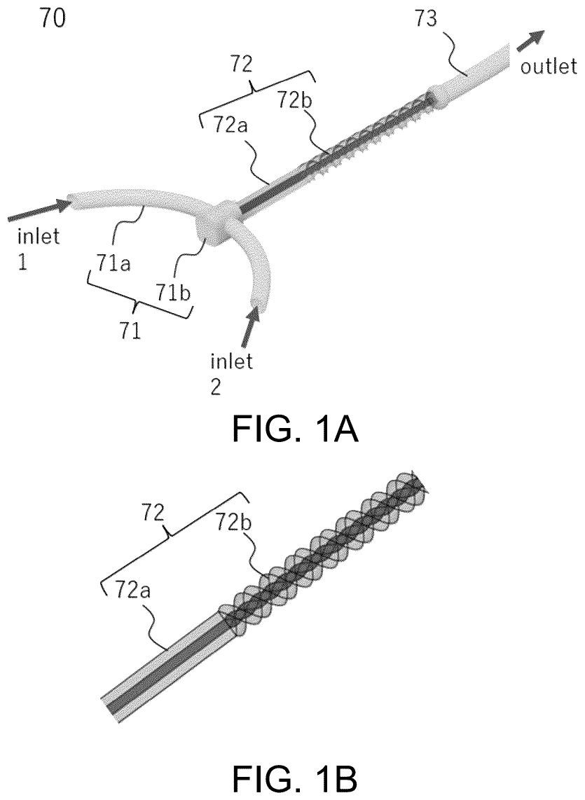

FIG. 1A is a perspective view of a micromixer. A micromixer 70 includes a first portion 71 and a second portion 72, the first portion 71 providing a first flow passage, the second portion 72 providing a second flow passage branched from the middle of the first portion 71. Both ends of the first portion 71 form inlets 1 and 2, and samples can be introduced into an introduction passage 71a from the inlets 1 and 2. The introduction passage 71a provides a flow passage having a diameter of, for example, 1 mm or less. The introduction passage 71a for samples communicates with a separator 71b. The separator 71b is a member for guiding the samples, which are introduced from the inlets 1 and 2, to the second portion 72. That is, the separator 71b prevents the sample introduced from the inlet 1 from advancing to the inlet 2 and prevents the sample introduced from the inlet 2 from advancing to the inlet 1, and causes these samples to flow to the second portion 72. The second portion 72 includes a straight flow passage portion 72a and a twisted portion 72b. According to an example, the straight flow passage portion 72a includes a straight flow passage, and the inner wall of the straight flow passage portion 72a is also uniform in the fluid advancing direction without twisting. On the other hand, the inner wall of the twisted portion 72b has a spiral shape along the longitudinal direction of the second portion 72. Accordingly, a fluid passing through the twisted portion 72b is affected by this shape of the inner wall. In addition, the twisted portion 72b also has a twisted outer shape. According to an example, a first sample is supplied from the inlet 1, and a second sample is supplied from the inlet 2. The first sample and the second sample are guided to the second portion 72 by the separator 71b, merge at the straight flow passage portion 72a, and advance through the second flow passage formed in the second portion 72. Then, the first sample and the second sample pass through the twisted portion 72b, thereby being mixed together. The mixed sample is taken out from a tube 73 attached to, for example, the second portion 72.

FIG. 1B is an enlarged view of the second portion 72. According to an example, this second portion 72 is a single fiber that includes the straight flow passage portion 72a and the twisted portion 72b. A light-colored portion is a tube portion, that is, a base body, and a dark-colored portion is a flow passage portion. FIG. 1B shows that the flow passage in the twisted portion 72b is formed to be twisted. With this twisting, the inner wall of the second flow passage has a spiral shape, and therefore mixing of fluids is promoted. For example, in a straight micromixer in which the inner walls are formed only by flat surfaces, two kinds of fluids can be hardly mixed, and such a tendency does not change even when the length of the fiber is increased. In contrast, according to the micromixer shown in FIG. 1A, two kinds of fluids can be mixed by the twisted portion 72b, in which the inner wall has a spiral shape, and mixing can be improved as the length of this fiber is increased.

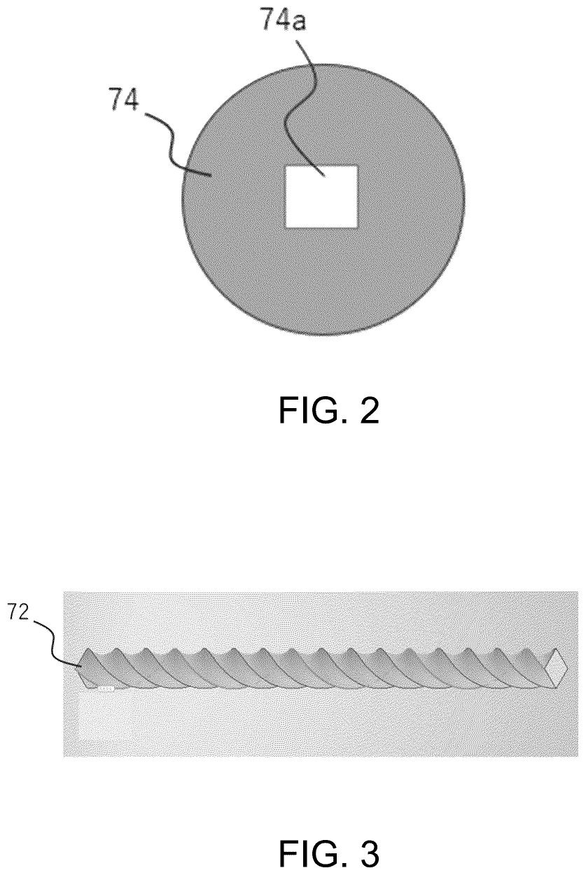

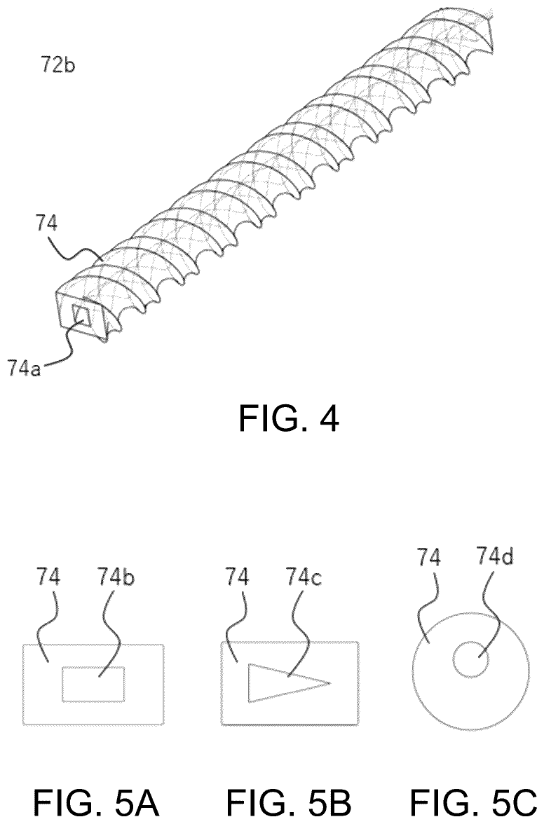

A method for manufacturing the micromixer 70 will be described. The method for manufacturing the micromixer 70 includes preparing a preform in which a base body includes a hole, and forming a fiber by hot drawing the preform in one direction while the preform is rotated. FIG. 2 is a diagram showing an example of the cross-sectional shape of the preform. This preform includes a base body 74. The base body 74 includes, at the center portion thereof, a hole 74a having a quadrangular shape. When this preform is processed by a rotary hot-drawing apparatus, it is possible to manufacture a fiber including a channel in which the inner wall has a spiral shape. FIG. 3 is a diagram showing a channel shape at the twisted portion 72b. It is shown at the right end of FIG. 3 that the cross section of the twisted portion 72b has a quadrangular shape. In addition, FIG. 4 is a perspective view of the twisted portion 72b, and shows the twisted portion 72b in diagram form, thus illustrating the shape of the entire twisted portion 72b. FIG. 4 illustrates that the base body 74 has a spiral outer shape and, in addition, the inner wall of the hole 74a also has a spiral shape.

FIGS. 5A˜5C are cross-sectional views showing the degree of freedom in the channel shape at the twisted portion. FIG. 5A is a diagram showing an example in which the base body 74 includes a hole 74b having a rectangular shape. The hole 74b has a rectangular cross-sectional shape, unlike the substantially square hole shown in FIG. 4. FIG. 5B is a diagram showing an example in which the base body 74 includes a hole 74c having a triangular shape. FIG. 5C is a diagram showing an example in which a hole 74d having a circular shape is formed at a position offset from the center when viewed in a cross-sectional view. In this case, the flow passage has a spiral shape. When a hole is formed in a base body during formation of a preform, by causing the hole to have a quadrangular shape, a triangular shape, or a circular shape, or by locating the hole at the center when viewed in a cross-sectional view or at a position offset from the center when viewed in a cross-sectional view, a twisted portion having any of various spiral shapes can be formed. Such degree of freedom in the shape of the twisted portion can be ensured by using a rotary hot-drawing apparatus. Well-known micromixers have been manufactured by mechanically processing PMMA plates using, for example, micro-CNC machining or micro-milling. Mechanical processing tends to limit manufacturable channel shapes. In contrast, when the rotary hot-drawing apparatus is used, the shape and the position of a hole provided in a preform can be freely adjusted, and therefore hot drawing this preform can provide a fiber including a channel having a previously nonexistent shape.

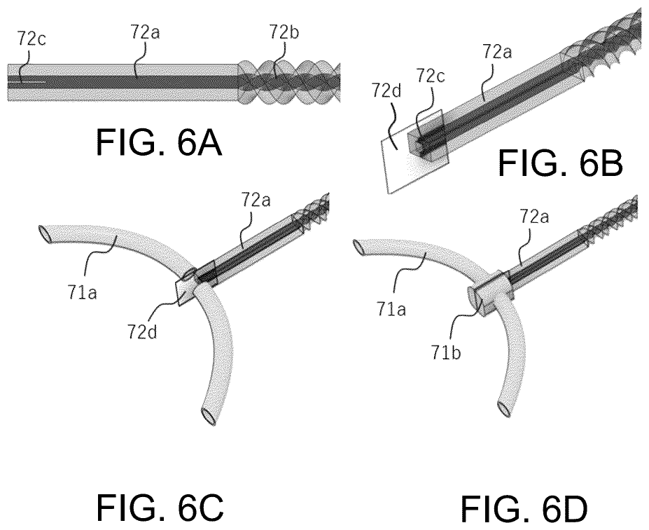

After the second portion 72 is formed by rotary hot drawing in this manner, the first portion 71 is connected to the second portion 72. FIGS. 6A˜6D show diagrams showing an example of a process for fixing the first portion 71 to the second portion 72. First, a narrow groove is formed in the second portion. A narrow groove 72c formed in the straight flow passage portion 72a is shown in FIG. 6A. Next, a film (thin film) is fitted in this groove 72c. A film 72d is shown in FIG. 6B. The film 72d is made of PMMA, for example. By fitting this film 72d into the groove 72c of the straight flow passage portion 72a, the film 72d is fixed to the straight flow passage portion 72a. At a portion where the film 72d is present, the flow passage in the straight flow passage portion 72a is split into two channels by the film 72d. Next, as shown in FIG. 6C, the introduction passage 71a having a tubular shape is disposed in the vicinity of the film 72d. Next, as shown in FIG. 6D, the separator 71b is fixed to the introduction passage 71a and the second portion. Although a fixing method is not particularly limited, an adhesive agent may be used. The separator 71b may have any shape that guides a fluid in the introduction passage 71a to the straight flow passage portion 72a. Next, the tube 73 is fixed to the second portion 72 at a portion on the side opposite to the separator 71b.

With the above-described micromixer, it is possible to mix reagents with high efficiency across various Reynolds number ranges.

### Second Embodiment

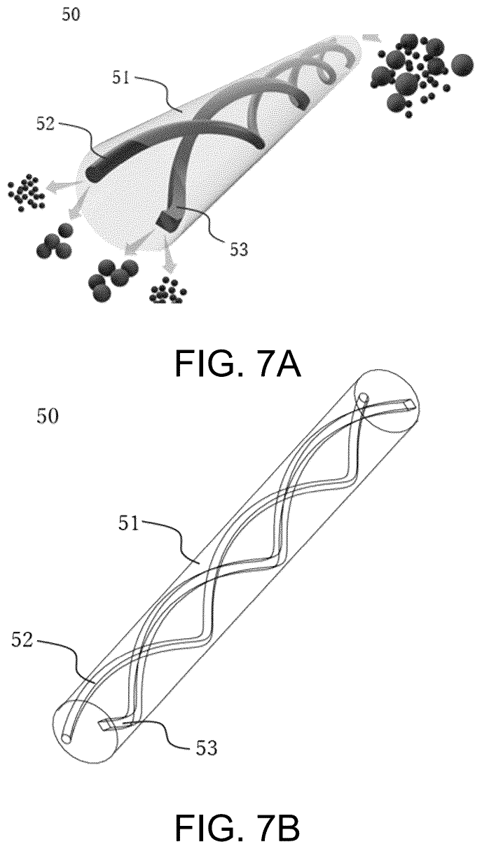

A second embodiment relates to a sorter device including a fiber. FIGS. 7A˜7B are perspective views showing an example configuration of the fiber. This fiber 50 includes a base body 51 having an elongated shape, and spiral flow passages 52 and 53 provided in the base body 51. The base body 51 may be made of, for example, a thermoplastic polymer or a thermoplastic elastomer. The spiral flow passages 52 and 53 are flow passages formed to have helical shapes along the side surface of the base body 51. FIG. 7A shows that a fluid containing two kinds of particles flows through the spiral flow passages 52 and 53, thereby being separated into two components. The number of spiral flow passages may be one or three or more. According to an example, the fiber 50 exhibits flexibility and can be bent.

FIG. 7B is a schematic view of FIG. 7A. FIG. 7B shows that the spiral flow passage 52 is a flow passage having a circular cross-sectional shape, and the spiral flow passage 53 is a flow passage having a quadrangular cross-sectional shape.

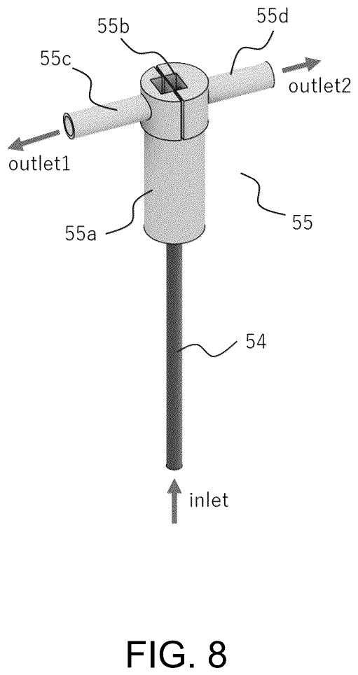

FIG. 8 is a perspective view of the sorter device. The sorter device includes a fiber 54 and a separator 55. Although the fiber 54 is similar to the fiber 50 shown in FIGS. 7A and 7B, the fiber 54 differs from the fiber 50 in that the number of spiral flow passages is one. The separator 55 includes a connection portion 55a, a branch portion 55b, a first flow passage 55c, and a second flow passage 55d. The connection portion 55a is connected to the fiber 54. The branch portion 55b is a portion that branches components between those on the outer side of the spiral flow passage and those on the inner side of the spiral flow passage. According to an example, the component on the outer side of the spiral flow passage flows into the first flow passage 55c, and the component on the inner side of the spiral flow passage flows into the second flow passage 55d. In this manner, the separator 55 communicates with the spiral flow passage and branches the components in the spiral flow passage into the first flow passage 55c and the second flow passage 55d.

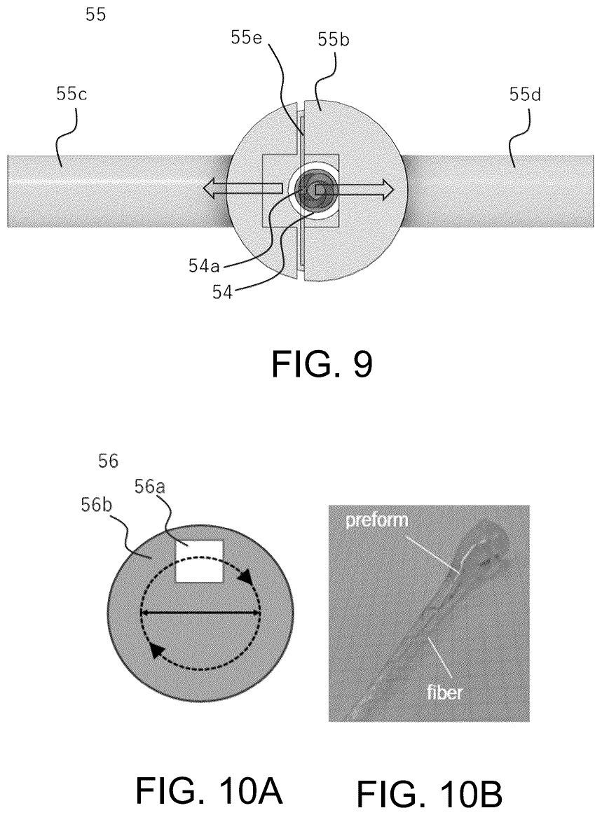

FIG. 9 is a plan view of the separator 55. For the sake of convenience of description, a portion of the branch portion 55b is shown transparently. The branch portion 55b includes a thin film 55e. This thin film 55e is disposed directly above a spiral flow passage 54a of the fiber 54. In other words, the thin film 55e is provided to be substantially parallel to a direction in which the fluid advances in the spiral flow passage. According to an example, a slit extending to the spiral flow passage is formed in the base body of the fiber 54, and the thin film 55e is fitted into this slit, and it is therefore possible to cause the thin film 55e to serve as a fluid splitter plate in the spiral flow passage. This thin film 55e separates the components in the spiral flow passage 54a into an outer component and an inner component. The outer component is a component that flows through the spiral flow passage 54a in a region close to the outer edge of the fiber 54. The inner component is a component that flows through the spiral flow passage 54a in a region close to the center of the fiber 54. The branch portion 55b guides the outer component to the first flow passage 55c, and guides the inner component to the second flow passage 55d. The components of the fluid in the spiral flow passage can be separated in this manner.

With such a spiral flow passage, components can be separated or mixed by utilizing an inertial force based on the size of cells or particles. Such a device is widely applicable in the fields of life sciences, chemistry, materials engineering, and the like.

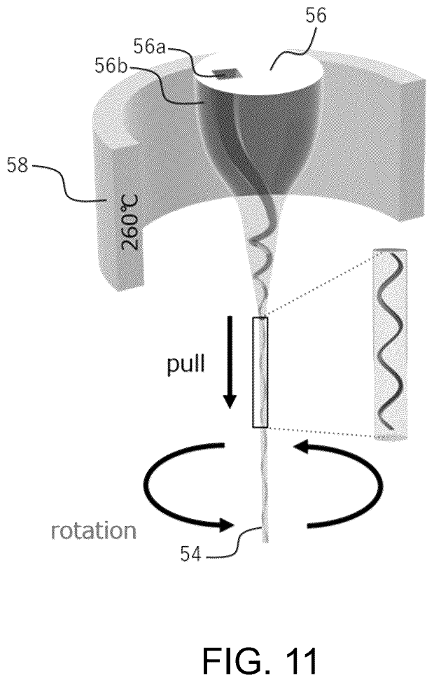

A method for manufacturing such a sorter device will be described. A fiber including spiral flow passages can be manufactured by, for example, preparing a preform, and hot drawing the preform using a rotary hot-drawing apparatus while the preform is rotated. FIG. 10A is a cross-sectional view of a preform 56. The preform 56 includes a base body 56b and a hole 56a located at a position offset from the center of the base body. When such a preform is processed by the rotary hot-drawing apparatus, the hole 56a is formed into a helical shape, so that it is possible to form a spiral channel in a base body material. FIG. 11 is a diagram showing a state in which a preform is subjected to rotary hot drawing. In this example, a preform is heated by a heater 58 heated to 260° C. and is subjected to rotary hot drawing, and therefore the fiber 54 including a spiral flow passage is formed. FIG. 10B is a photograph showing a portion of the preform and a portion of the fiber that is subjected to rotary hot drawing.

The separator 55 can be formed into any shape using, for example, a 3D printer.

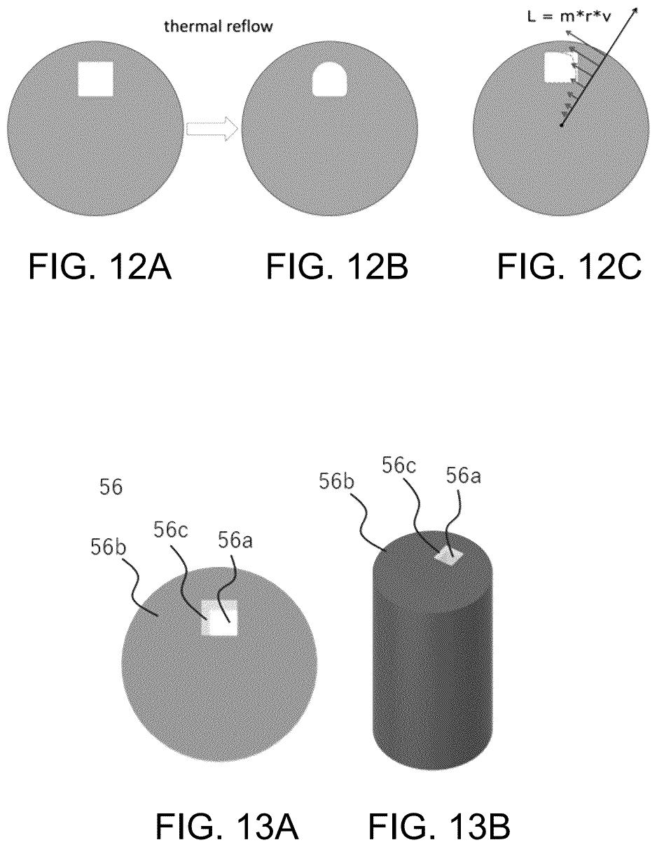

As a result of studies conducted by the inventors, there have been cases in which the cross-sectional shape of a channel is deformed during hot drawing of a preform. FIGS. 12A˜12C are diagrams illustrating a deformation mechanism of the spiral channel. FIG. 12A shows that the cross section of the spiral channel before deformation has a quadrangular shape. FIG. 12B shows that such a spiral channel having a quadrangular shape was deformed by hot drawing performed with rotation. Particularly, the spiral channel is significantly deformed in a region close to the outer side of the fiber, and therefore, in such a region, the cross-sectional shape of the spiral channel is rounded due to elimination of the corners of the quadrangular shape. FIG. 12C illustrates the deformation mechanism of the spiral channel. Due to rotation, the preform receives a larger force at positions closer to the outer edge of the preform, and this causes the preform to be significantly deformed particularly in the region close to the outer edge of the fiber.

Such a problem can be suppressed by applying a second base body material to the base body material. FIG. 13A˜13B are diagrams showing a preform including the second base body material. FIG. 13A is a cross-sectional view, and shows that a second base body material 56c is applied to the wall surface of the hole 56a of the base body 56b. According to an example, the second base body material 56c is HIPS (impact resistance polystyrene), and the base body 56b is made of polycarbonate. According to another example, the base body material 56c may be replaced with any polymer, and the base body 56b may be made of any polymer. In the example shown in FIG. 13A, the hole 56a has a quadrangular shape when viewed in a cross-sectional view, and the second base body material 56c is applied to two of four wall surfaces that surround this hole 56a. FIG. 13B is a perspective view of the preform shown in FIG. 13A. When this preform is processed by the rotary hot-drawing apparatus, it is possible to form a fiber including a spiral flow passage with the shape of the hole 56a maintained.

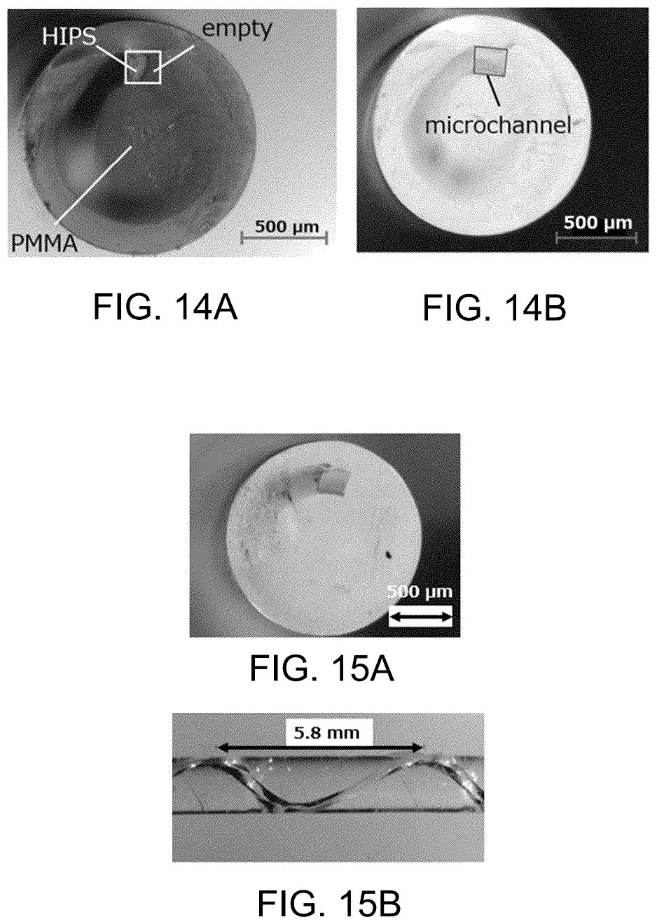

After the rotary hot drawing is performed, it is necessary to remove the second base body material 56c. According to an example, by injecting a limonene solution from a silicone tube into portions where the second base body material 56c is present, it is possible to dissolve the second base body material 56c. FIG. 14A is a photograph of a cross section of the fiber before the second base body material is removed. It was verified that HIPS, which is the second base body material, is present at a portion of the spiral channel. FIG. 14B is a photograph of a cross section of the fiber after the second base body material is removed. It was verified that spraying a limonene solution onto the second base body material dissolves the second base body material, enabling a spiral channel with a quadrangular shape in cross section to be obtained. According to the experiments performed by the inventors, when the rotational speed of a preform during rotary hot drawing is more than approximately 50 rpm, the spiral channel becomes filled with HIPS. When the spiral channel becomes filled with HIPS, it becomes difficult to dissolve and remove the HIPS. For this reason, it is necessary to maintain a gap in the spiral channel, the gap being free of HIPS. When the rotational speed is reduced and the pitch of the spiral channel is set to, for example, 4 mm or more, it is possible to suppress a situation in which the spiral channel becomes filled with HIPS, and it is therefore possible to easily dissolve HIPS. By supplying the second base body material and ultimately removing the second base body material in this manner, it is possible to form a spiral channel while the cross-sectional shape of the hole of the fiber is maintained. Although the spiral channel has a quadrangular cross-sectional shape in this example, other cross-sectional shapes may be adopted in other examples.

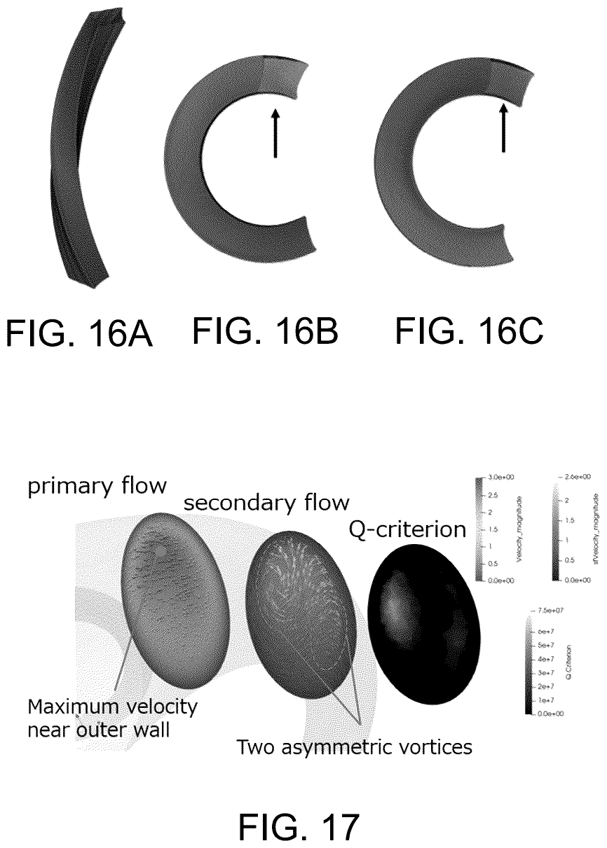

Next, an example of manufacturing a fiber including a spiral channel will be described. By subjecting a preform, to which the second base body material is applied, to rotary hot drawing, it was possible to manufacture a fiber including a spiral channel, with a quadrangular cross-sectional shape of the spiral channel maintained. FIG. 15A is a photograph of a cross section of the fiber that is subjected to rotary hot drawing. It was verified that the spiral channel maintains a substantially quadrangular cross-sectional shape. FIG. 15B is a photograph of the front side of the manufactured fiber. It was verified that the pitch of the spiral channel is 5.8 mm. FIGS. 16˜16C are diagrams showing CT scan results from portions of the spiral channel in the formed fiber. FIG. 16A shows an overview of the spiral channel. FIG. 16B shows a top-view image of the spiral channel. FIG. 16C is a bottom-view image of the spiral channel. From FIGS. 16A to 16C, it was found that a substantially quadrangular cross-sectional shape of the spiral channel is maintained. Particularly from portions in FIGS. 16B and 16C indicated by arrows, it can be understood that the amount of deformation of the cross-sectional shape of the spiral channel was minute, and a substantially quadrangular shape was maintained.

When perspective is changed, that is, when deformation of the cross-sectional shape of the channel during rotary hot drawing of a preform is actively utilized, it is possible to achieve a channel having a cross-sectional shape that has not previously been formable. In this case, the change in the cross-sectional shape of the channel caused by rotary hot drawing is directly adopted without supplying the second base body material. By adopting such a configuration, it is possible to manufacture, for example, a fiber including a channel having an elliptical or substantially elliptical cross-sectional shape, or a fiber including a channel having a semicircular or substantially semicircular cross-sectional shape.

To sort sample particles, that is, to perform sorting, vortices (Dean vortices) forming a pair and referred to as “Dean flow” are required, the vortices being symmetric in the vertical direction. According to a theoretical calculation performed by the inventors, it is expected that reducing the pitch of the spiral channel to approximately 0.4 mm is required in order to cause a Dean flow with sufficient symmetry. Currently, the minimum pitch that allows manufacturing with the channel shape maintained is approximately 4 mm, and therefore it is necessary to minimize the pitch by selecting a material or by devising manufacturing conditions.

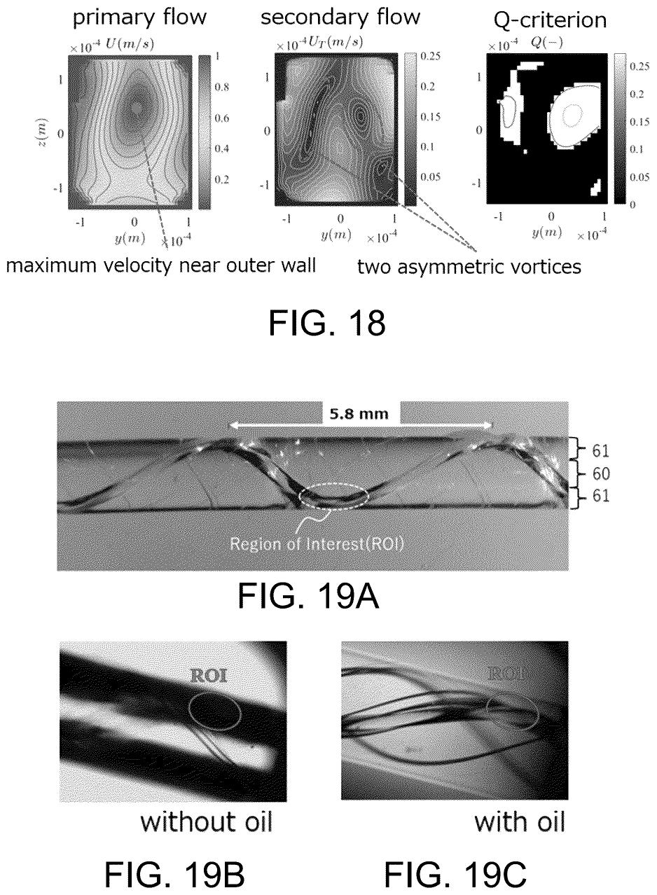

FIG. 17 is a diagram showing the result of the theoretical calculation of the flow profile of the spiral channel. A primary flow, a secondary flow, and a Q-criterion, which is the detection index of the vortex, are plotted. As a result of the theoretical calculation, it was found that the maximum flow velocity occurs in the vicinity of the outer wall of the channel. It was also verified that two vortices of a fluid were generated as shown by broken lines in the drawing. FIG. 18 is a diagram showing the analysis result from micro particle image velocimetry (PIV). In FIG. 18, primary flow, secondary flow, and distribution of Q-criterion for a case in which the flow rate of a fluid in the spiral channel is 2.0 ml/min are shown by contour lines and colors. In the same manner as the simulation, the maximum flow velocity occurs in the vicinity of the outer wall. In addition, vortices can be observed at two positions surrounded by broken lines. Accordingly, in both the theoretical calculation and the experiment, the generation of two vortices of a fluid was verified. From these results, high controllability of the fluid in the flow passage of the fiber can be expected.

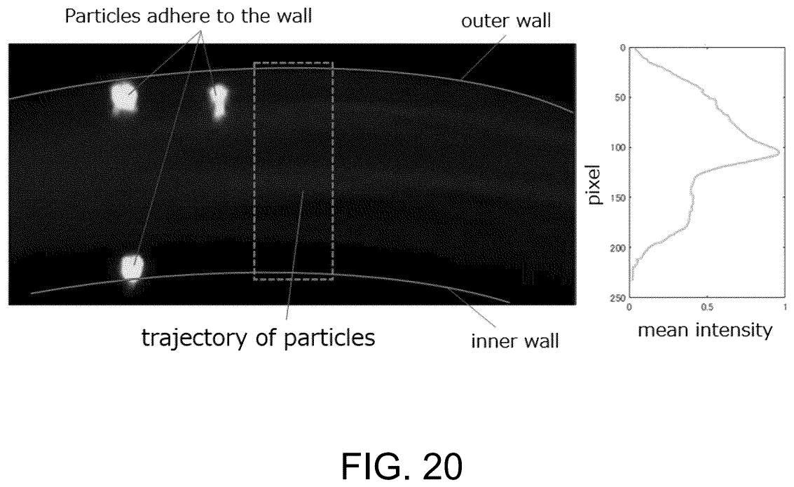

To verify whether a substance to be separated is sorted appropriately, it is necessary to experimentally obtain the equilibrium position of particles in the channel using fluorescent particles. To obtain distribution in the radial direction, it is necessary to observe a portion in the vicinity of the outer edge distant from the axis. When the fiber was observed from the side, although the observation of the inside of the spiral channel was easy at the axis portion of the fiber, observation of the inside of the spiral channel was difficult in the vicinity of the outer edge distant from the axis. FIG. 19A shows a spiral channel region 60 and a spiral channel region 61, the spiral channel region 60 being located at the axis portion of the fiber, the spiral channel region 61 being located in the vicinity of the outer edge distant from the axis. In fluorescence observation in which particles are visualized by irradiating the particles with light of a particular wavelength, observation of the spiral channel region 61 was difficult, the spiral channel region 61 being located in the vicinity of the outer edge. In FIG. 19A, this spiral channel region 61 is defined as Region of Interest (ROI). FIG. 19B is a photograph of the fiber observed in air. It can be understood that observation at the ROI is difficult. FIG. 19C is a photograph for a case in which the fiber is immersed into an oil with a refractive index close to that of PMMA, and is subjected to fluorescence observation. It can be understood from FIG. 19C that the inside of the spiral channel can be observed at both the axis portion and the portion in the vicinity of the outer edge distant from the axis. FIG. 20 is a fluorescence photograph of the ROI in the fiber, taken with the fiber immersed in oil. FIG. 20 shows a fluorescence image of the ROI when fluorescent particles are injected, and it can be understood that the trajectory of particles is captured appropriately. Although adhesion of a slight amount of particles to the wall surface is observed, a problem in observation is not verified. Radial distribution of fluorescence intensity in a region surrounded by a dotted line is also plotted on the right side. This is obtained by normalizing the time average. From these results, a basis for experimentally obtaining the equilibrium position of the particles in the channel was established.

### Third Embodiment

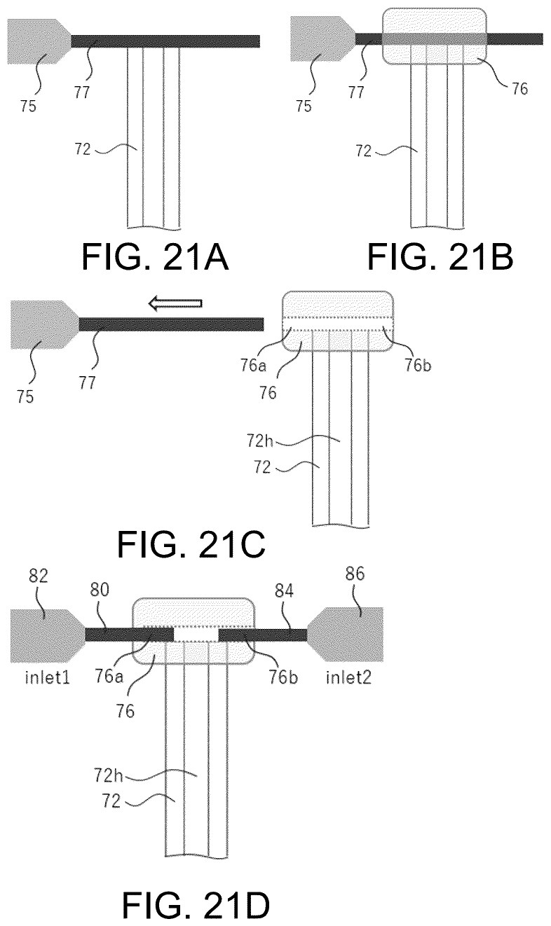

FIGS. 21A˜21C are cross-sectional views showing a method for manufacturing a micromixer according to another embodiment. First, as shown in FIG. 21A, a microneedle 77 is caused to come into contact with the cross section of the second portion 72. According to an example, as described above, the second portion 72 is a single fiber that includes the straight flow passage portion and the twisted portion. According to another example, the second portion 72 may have another configuration. The microneedle 77 blocks at least a portion of the channel in the second portion 72 while being in contact with the cross section of the second portion 72. The microneedle 77 has φ (diameter) of 500 μm, for example. According to an example, the microneedle 77 is provided with a gripping portion 75, and it is therefore possible to increase operability.

Next, the process proceeds to a step shown in FIG. 21B. FIG. 21B shows that an adhesive agent 76 is applied at a connection portion between the second portion 72 and the microneedle 77. According to an example, an adhesive agent exhibiting fluidity is caused to flow to the connection portion between the second portion 72 and the microneedle 77, and the adhesive agent is cured, thereby fixing the second portion 72 and the microneedle 77. According to an example, by causing an adhesive agent exhibiting fluidity to flow into a mold or a metal mold, it is possible to form the adhesive agent into a predetermined shape.

Next, the process proceeds to a step shown in FIG. 21C. FIG. 21C shows that the microneedle 77 is withdrawn from the cured adhesive agent 76. According to an example, the microneedle 77 is removed from the adhesive agent 76 by carefully withdrawing the gripping portion 75 in the direction of an arrow. With such an operation, a gap having an elongated shape with φ of approximately 500 μm, for example, is formed in the adhesive agent 76. This gap provides a first flow passage. FIG. 21C shows that the first flow passage is straightly formed from one end 76a to the other end 76b, and penetrates through the adhesive agent 76. The through hole of the adhesive agent 76 communicates with a channel 72h in the second portion 72, and therefore a flow passage having a T shape is provided.

Next, the process proceeds to a step shown in FIG. 21D. FIG. 21D shows that a first hollow needle 80 and a second hollow needle 84 are inserted into the through hole of the adhesive agent 76. The first hollow needle 80 is inserted into the one end 76a of the first flow passage in the adhesive agent 76, and the second hollow needle 84 is inserted into the other end 76b of the first flow passage in the adhesive agent 76. Each of the first hollow needle 80 and the second hollow needle 84 includes a through hole extending in the longitudinal direction. The diameter of the first hollow needle 80 and the diameter of the second hollow needle 84 may be matched with, for example, the diameter of the first flow passage in the adhesive agent 76. In the example shown in FIG. 21D, the first hollow needle 80 and the second hollow needle 84 are not in contact with each other, and are spaced apart from each other. The region between the first hollow needle 80 and the second hollow needle 84 is located at a position directly above the channel 72h, and therefore the first flow passage communicates with the channel 72h, which is a second flow passage.

In the example shown in FIG. 21D, a first injection portion 82 is connected to the first hollow needle 80, and a second injection portion 86 is connected to the second hollow needle 84, the first injection portion 82 supplying liquid to the first hollow needle 80, the second injection portion 86 supplying liquid to the second hollow needle 84. The micromixer shown in FIG. 21D may include the following components as the first portion.

The adhesive agent 76 providing the first flow passage while covering the distal end portion of the second portion 72,
the first hollow needle 80 inserted into one end side of the first flow passage, and
the second hollow needle 84 inserted into the other end side of the first flow passage.

The first hollow needle 80 and the second hollow needle 84 serve as injector needles. For example, by injecting different colored liquids into the first hollow needle 80 and the second hollow needle 84, these colored liquids can be caused to advance from the straight flow passage portion to the twisted portion in the second portion, and to be mixed together. Samples are mixed as described above.

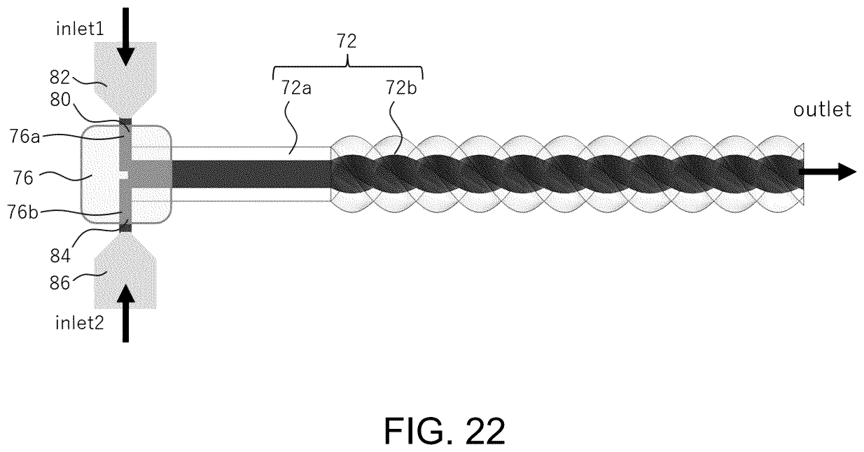

FIG. 22 is a diagram showing a usage example of the micromixer of the present embodiment. In the micromixer shown in FIG. 22, the second portion 72 includes a straight flow passage portion 72a and a twisted portion 72b. Liquids supplied from the first injection portion 82 and the second injection portion 86, forming inlets 1 and 2, are supplied to the straight flow passage portion 72a through the first hollow needle 80 and the second hollow needle 84, and then advance to the twisted portion 72b, thereby being mixed together. In FIG. 22, fluid flow directions are shown by arrows.

An evaluation experiment of mixing efficiency was performed using the micromixer shown in FIG. 22. An evaluation method is as follows. Two kinds of colored liquids are respectively injected from the inlets 1 and 2, and the degree of mixing is evaluated in the vicinity of an outlet. The degree of mixing was evaluated using the standard deviation of hue. Relative mixing efficiency was calculated using the degree of mixing immediately after the two kinds of colored liquids are merged and using the degree of mixing in the vicinity of the outlet. To verify that the T-shaped passage functions appropriately and that the two kinds of colored liquids are separated in equal proportions immediately after the two liquids are merged, the straight flow passage portion 72a in which mixing does not advance was prepared.

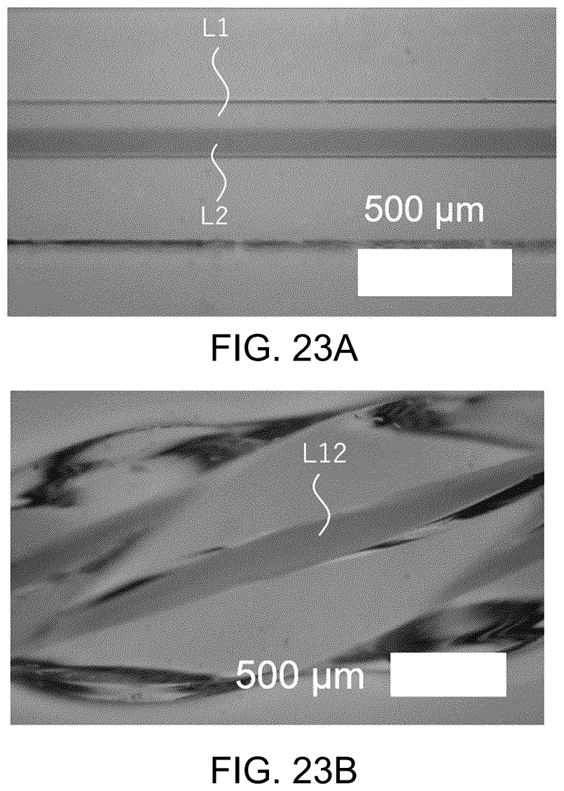

FIG. 23A shows an image of the inside of the channel photographed immediately after the two liquids were merged in this evaluation experiment. From this image, it was observed that a first liquid L1 and a second liquid L2 were separated in equal proportions. FIG. 23B shows an image of the inside of the channel photographed at a position in the vicinity of the outlet in this evaluation experiment. From this image, a uniform liquid L12 formed by mixing the first liquid and the second liquid was observed. In the present example, the first liquid L1 was yellow before mixing, the second liquid L2 was blue before mixing, and the liquid L12 formed after mixing was green.

Next, the dependence of mixing efficiency on Reynolds number was investigated for two micromixers. A Reynolds number Re is defined by the following formula.

$$Re = ρ vL / μ$$

where “ρ” denotes density, “v” denotes flow velocity, “L” denotes channel width, and “μ” denotes viscosity coefficient. Because parameters other than the flow velocity v are constants, investigating the dependence of mixing efficiency on Reynolds number is equivalent to investigating the dependence of mixing efficiency on the flow velocity. The micromixer is required to maintain high mixing efficiency over a wide range of Reynolds numbers.

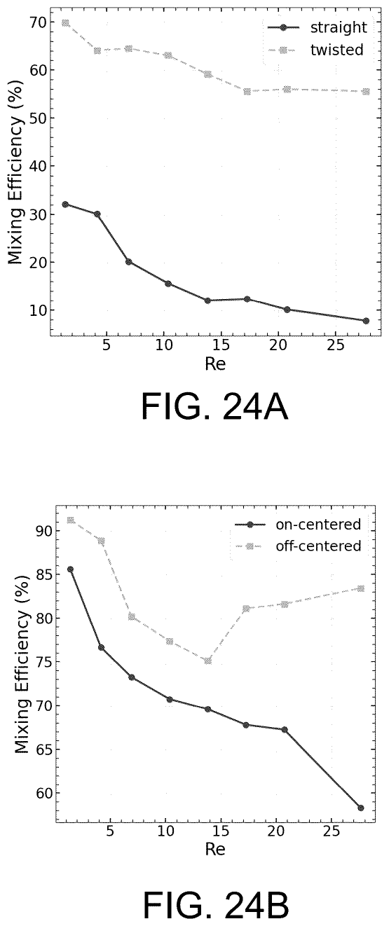

FIG. 24A is a graph showing experimental results obtained by investigating the dependence of mixing efficiency on Reynolds number for a straight mixer (straight micromixer) and a twisted mixer (twisted micromixer). The straight mixer is a micromixer in which the second portion includes only the straight flow passage portion and does not include the twisted portion. That is, for example, the straight mixer is a micromixer in which the twisted portion 72b of the device shown in FIG. 22 is replaced with the same structure as the straight flow passage portion 72a, so that the entire second portion 72 includes only the straight flow passage portion. On the other hand, the twisted mixer is a mixer including the twisted portion, and is a micromixer shown in FIG. 22, for example.

As shown in FIG. 24A, for example, at low Reynolds numbers, such as a Reynolds number of 9 or less, a relatively high mixing efficiency was obtained in both the straight mixer and the twisted mixer. This is because low flow velocity increases liquid residence time in the micromixer, and mixing advances sufficiently due to molecular diffusion. On the other hand, for example, when the Reynolds number is high, that is, 10 or more, and the flow velocity is high, the fluid has a short residence time. In this case, it can be understood that a larger Reynolds number causes a noticeable reduction in mixing efficiency in the straight mixer. In contrast, it can be understood that, in the twisted mixer, even when the Reynolds number is increased, a relatively high mixing efficiency is maintained. Accordingly, it can be regarded that the micromixer including the twisted portion was suggested to be advantageous for promotion of mixing.

Next, the influence of the shape of the twisted portion on mixing efficiency was investigated over a wide range of Reynolds numbers. In this investigation, the following two micromixers were used.

A micromixer (referred to as “first micromixer”) in which the inner wall of the flow passage in the twisted portion is formed to have a spiral shape along the longitudinal direction of a second portion.

A micromixer (referred to as “second micromixer”) in which the inner wall of the flow passage in the twisted portion is formed to have a spiral shape and, in addition, the flow passage itself is formed to have a helical shape.

That is, in the first micromixer, as shown in FIG. 22, although the inner wall of the twisted portion 72b has a spiral shape, the flow passage center line of the twisted portion 72b has a straight shape. The flow passage center line refers to a line that connects the center points of the respective cross sections of the flow passage. On the other hand, in the second micromixer, the inner wall of the twisted portion has a spiral shape and, in addition, the flow passage center line of the twisted portion has a helical shape.

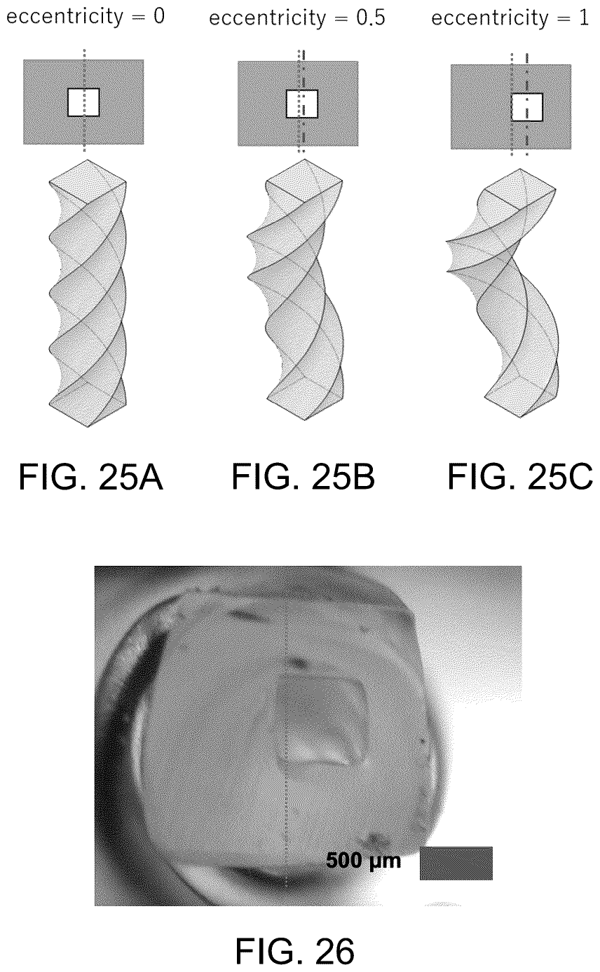

Here, a method for causing the flow passage center line to have a straight shape or a helical shape will be described with reference to FIGS. 25A˜25C. FIG. 25A is a diagram showing an example of a twisted portion having a flow passage center line having a straight shape. A cross-sectional view of the twisted portion is shown in the upper portion of FIG. 25A. This cross-sectional view shows that the base body includes a quadrangular flow passage at the center thereof. A broken line is the center line of the base body, and this center line aligns with the center line of the flow passage. When the deviation amount of the channel from the center axis of the fiber is defined by the eccentricity parameter, the eccentricity of the fiber shown in FIG. 25A is 0. It is shown in the lower portion of FIG. 25A that the inner wall of the twisted portion is formed to have a spiral shape by rotary hot drawing. When an eccentricity is 0, the flow passage center line has a straight shape.

FIG. 25B is a diagram showing an example in which the flow passage center line of the twisted portion has a helical shape. It is shown in the upper portion of FIG. 25B that the broken line, which is the center line of the base body, is deviated from a chain line, which is the center line of the flow passage. Assuming a length from the broken line to the left end of the flow passage as “1”, a length from the broken line to the right end of the flow passage is “2”. In this case, it is defined that the eccentricity of the fiber is 0.5. It is shown in the lower portion of FIG. 25B that the inner wall of the twisted portion is formed to have a spiral shape by rotary hot drawing. It can be also understood that the flow passage center line connecting the center points of the respective cross sections of the flow passage in the twisted portion has a helical shape, the respective cross sections being perpendicular to the longitudinal direction. FIG. 26 is a photograph of a cross section of an actually manufactured fiber having an eccentricity of 0.5.

FIG. 25C is also a diagram showing an example in which the flow passage center line of the twisted portion has a helical shape. It is shown in the upper portion of FIG. 25C that the broken line, which is the center line of the base body, is deviated from the chain line, which is the center line of the flow passage. The broken line is located at the left end of the flow passage. In this case, it is defined that the eccentricity of the fiber is 1. It is shown in the lower portion of FIG. 25C that the inner wall of the twisted portion is formed to have a spiral shape by rotary hot drawing. It can be also understood that the flow passage center line connecting the center points of the respective cross sections of the flow passage in the twisted portion has a helical shape, the respective cross sections being perpendicular to the longitudinal direction. An increase in eccentricity increases the diameter of a circle drawn by a helical shape. By using the rotary hot-drawing apparatus, it is possible to easily adjust an eccentricity.

FIG. 24B is a graph showing the influence of such an eccentricity on mixing efficiency. This experiment was conducted under two conditions, that is, an on-centered condition and an off-centered condition. The on-centered condition means that an eccentricity is 0 (eccentricity=0), and the off-centered condition means that an eccentricity is 0.5 (eccentricity=0.5). An experiment was conducted on these two fibers. Data for the on-centered condition was obtained from a micromixer including the twisted portion in which the inner wall of the flow passage has a spiral shape and the flow passage center line has a straight shape. That is, the data for the on-centered condition is data obtained from the above-described first micromixer. In this case, at low Reynolds numbers, that is, approximately 2, high mixing efficiency is obtained, whereas at high Reynolds numbers, mixing efficiency significantly decreases. Data for the off-centered condition was obtained from a micromixer including the twisted portion in which the inner wall of the flow passage has a spiral shape and the flow passage center line has a helical shape. That is, the data for the off-centered condition data is data obtained from the above-described second micromixer. In this case, although a decrease in mixing efficiency was observed when the Reynolds number was within a range from, for example, approximately 7 to 14, a high mixing efficiency of 80% or more was maintained also when the Reynolds number exceeded 14. High mixing efficiency was maintained overall in comparison with the experimental results from the on-centered condition. These experimental results demonstrate that mixing efficiency can be adjusted by adjusting an eccentricity.

### Fourth Embodiment

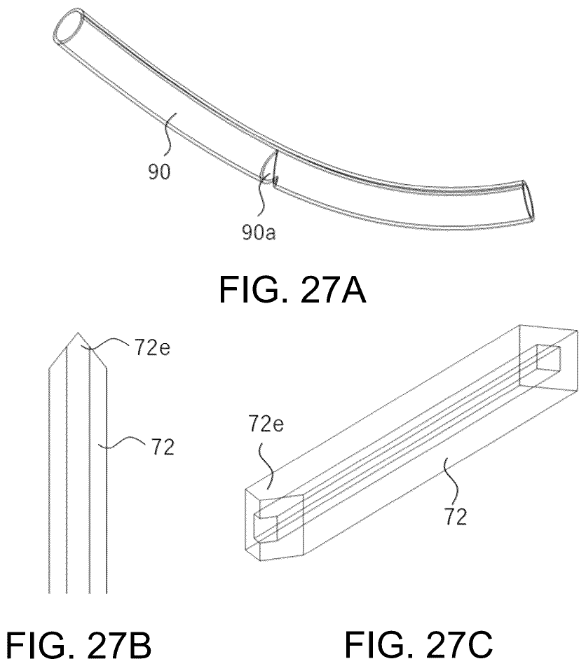

FIGS. 27A˜27C, 28, and 29 are cross-sectional views showing a method for manufacturing a micromixer according to another example. FIG. 27A is a diagram showing an example configuration of a first portion. A slit 90a that extends to a first flow passage is provided in a first portion 90. According to an example, the slit 90a having a V shape is formed in a tube forming the first portion 90. Although not particularly limited, when the first portion 90 is made of any polymer, for example, the slit can be easily formed. FIG. 27B is a cross-sectional view showing an example configuration of a second portion 72. The distal end of the second portion 72 forms a tapered portion 72e. According to an example, the tapered portion 72e is formed by processing the distal end of a fiber into a pointed shape using a blade. Although not particularly limited, when the second portion 72 is also made of, for example, any polymer, the distal end can be easily processed. FIG. 27C is a perspective view of the second portion 72. In the present example, the tapered portion 72e has a V shape when viewed in a plan view.

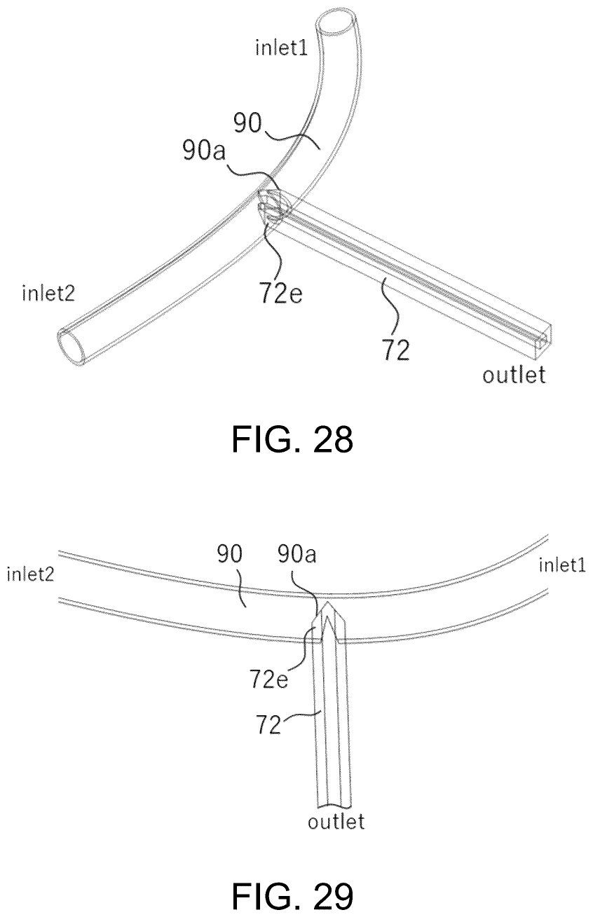

FIG. 28 is a diagram showing that the first portion and the second portion form a flow passage having a T shape. The tapered portion 72e of the second portion 72 is inserted into the first portion 90 at a portion where the slit 90a is formed. Consequently, the tapered portion 72e is fitted into the portion where the slit 90a is formed. According to an example, after this fitting, the connection portion between the first portion 90 and the second portion 72 can be fixed by an adhesive agent. Consequently, it is possible to provide a micromixer provided with a T-shaped passage in which liquids are injected from inlets 1 and 2 and are taken out from the outlet. Note that the twisted portion that is present in the second portion 72 is omitted in FIGS. 27A˜27C and 28.

FIG. 29 is a cross-sectional view of the micromixer shown in FIG. 28. The tapered portion 72e is located in the flow passage in the first portion, and therefore the flow passage having a T shape is formed.

To appropriately evaluate the influence of the twisted portion on mixing of liquids, mixing of liquids is suppressed as much as possible at portions other than the twisted portion. To suppress mixing of liquids at the portions other than the twisted portion, that is, at the first flow passage and the straight flow passage portion, variation in channel diameter may be reduced, or the cross-sectional shape of the channel may be approximated to a uniform shape. Such operations require microfabrication with high accuracy. In the manufacture of the above-described various micromixers, the first portion and the second portion can be fabricated with high accuracy by taking such points into account.

The present disclosure should not be construed as limiting, and various modifications are conceivable. For example, the micromixer, the sorter device, and the base body material of the fiber may be made of PMMA (polymethyl methacrylate resin), PC (polycarbonate), other materials, or a combination of these. Various features described in the present disclosure as examples may be combined. In the present disclosure, identical or corresponding constituent elements are given the same reference symbols, and repeated description is omitted.

### EXPLANATION OF SYMBOLS

50 fiber, 55 separator, 55a connection portion, 55b branch portion, 55c first flow passage, 55d second flow passage, 70 micromixer, 71 first portion, 72 second portion

1. A micromixer comprising:
a first portion configured to provide a first flow passage; and
a second portion configured to provide a second flow passage branched from a middle of the first flow passage, wherein
an inner wall of the second flow passage has a spiral shape along a longitudinal direction of the second portion.

2. The micromixer according to claim 1, wherein
the second portion includes a base body having an elongated shape, and
the second flow passage is formed to have a helical shape along a side surface of the base body.

3. The micromixer according to claim 1, wherein a cross-sectional shape of the second flow passage is a square shape, a rectangular shape, a triangular shape, or a circular shape.

4. The micromixer according to claim 1, comprising a film configured to split the second flow passage into two channels, the second flow passage being in contact with the first flow passage.

5. The micromixer according to claim 1, wherein the first portion includes an adhesive agent, a first hollow needle, and a second hollow needle, the adhesive agent providing the first flow passage while covering a distal end portion of the second portion, the first hollow needle being inserted into one end side of the first flow passage, the second hollow needle being inserted into another end side of the first flow passage.

6. The micromixer according to claim 1, wherein the first portion is provided with a slit extending to the first flow passage, a distal end of the second portion forms a tapered portion, and the tapered portion is fitted in the slit.

7. The micromixer according to claim 1, wherein the second portion includes a straight flow passage portion and a twisted portion, the straight flow passage portion being a straight flow passage that communicates with the first flow passage, the twisted portion communicating with the straight flow passage portion and having the inner wall having the spiral shape.

8. A sorter device comprising:
a fiber provided with a spiral flow passage; and
a separator communicating with the spiral flow passage and including a first flow passage and a second flow passage, a component on an outer side of the spiral flow passage flowing into the first flow passage, a component on an inner side of the spiral flow passage flowing into the second flow passage.

9. The sorter device according to claim 8, wherein
the fiber includes a base body having an elongated shape, and
the spiral flow passage is formed to have a helical shape along a side surface of the base body.

10. The sorter device according to claim 8, wherein
the separator includes a thin film provided in the spiral flow passage, and
the thin film guides the component on the outer side of the spiral flow passage to the first flow passage, and guides the component on the inner side of the spiral flow passage to the second flow passage.

11. A method for manufacturing a fiber, the method comprising:
forming a preform including a through hole and having a rod shape; and
forming a fiber by hot drawing the preform in one direction while the preform is rotated, wherein
a polymeric material is applied to the through hole of the preform, and
the through hole having a spiral shape is obtained by dissolving the polymeric material after the hot drawing.
